(19) United States
(12) Patent Application Publication
(10) Pub. No.: US 2026/0249871 A1
(43) Pub. Date: Aug. 27, 2026

(54) NON-TRANSITORY COMPUTER-READABLE STORAGE MEDIUM AND FOLLOWING VEHICLE APPROACH DETERMINATION SYSTEM

(71) Applicant: HONDA MOTOR CO., LTD., Tokyo (JP)

(72) Inventor: Shotaro ODATE, Tokyo (JP)

(21) Appl. No.: 19/545,289

(22) Filed: Feb. 20, 2026

(30) Foreign Application Priority Data
Feb. 27, 2025 (JP) 2025-029804

(51) Int. Cl. B60W 50/14; B60W 30/16; B60W 30/18

(52) U.S. Cl. CPC B60W 50/14; B60W 30/16; B60W 30/18163; B60W 2050/143; B60W 2050/146; B60W 2520/105; B60W 2554/4046; B60W 2554/802

(57) ABSTRACT

A following vehicle approach determination program stored in non-transitory computer-readable storage medium, when executed by a computer, causes the computer to execute information processing including determination related to approach of a following vehicle to an ego vehicle. The computer determines that an excessive approach state has occurred when an excessive approach affirmative condition is met and an excessive approach negative condition is not met, and determines that the excessive approach state has not occurred when the excessive approach affirmative condition is not met or the excessive approach negative condition is met. The excessive approach affirmative condition includes that the inter-vehicle distance is less than or equal to or is less than a threshold. The excessive approach negative condition includes that the computer recognizes that at least one of the ego vehicle and the following vehicle has made a lane change.

### TECHNICAL FIELD

The present invention relates to a following vehicle approach determination program (stored in a non-transitory computer-readable storage medium) for causing a computer to determine a state of a following vehicle and a following vehicle approach determination system.

### BACKGROUND ART

In recent years, efforts have been actively made to provide access to sustainable transport systems that take into account people in vulnerable situations among traffic participants. To achieve this, research and development for further improving safety and convenience of traffic through development of driving assistance technologies is attracting attention.

In recent years, so-called tailgating (driving performed with the intent to obstruct passage of another vehicle) has become a problem. One mode of the tailgating is failure to maintain the inter-vehicle distance. For example, JP2023-86576A discloses a method of determining whether tailgating is taking place based on an inter-vehicle distance and a period of time for which the inter-vehicle distance continues to be abnormally short.

Also, as one of the driving assistance technologies, an automatic lane change function is known. For example, JP2016-71513A discloses a recommend (or proposal)-type automatic lane change function in which, when a driving assist control device recommends a lane change of the vehicle to the driver and the driver agrees with the recommended lane change, the driving assist control device automatically performs the lane change.

However, immediately after a lane change, there may be a case where it is difficult to maintain an appropriate inter-vehicle distance depending on the position of the vehicle that has made the lane change relative to the preceding vehicle and the following vehicle. In the invention described in JP2023-86576A, there is a risk that such a state is also determined to be tailgating. Particularly, if an erroneous determination of tailgating is made in a vehicle provided with the recommend-type automatic lane change function, the driver may feel annoyed if the driver notices that the determination is in error or may cause the vehicle to make an unnecessary lane change if the driver does not notice that the determination is in error.

### SUMMARY OF THE INVENTION

To solve the above problems and moreover to contribute to development of a sustainable transport system, an object of the present invention is to provide a following vehicle approach determination program (stored in a non-transitory computer-readable storage medium) and a following vehicle approach determination system capable of making a determination of excessive approach of a following vehicle corresponding to tailgating with high accuracy.

To achieve the above object, one aspect of the present invention provides a non-transitory computer-readable storage medium comprising a following vehicle approach determination program, wherein the following vehicle approach determination program, when executed by a computer, causes the computer to execute information processing including determination related to approach of a following vehicle to an ego vehicle, wherein the information processing comprises: a following vehicle determination step of causing the computer to determine presence or absence of the following vehicle traveling on a same lane as the ego vehicle; an approach state determination step of, in a case where the following vehicle is present, causing the computer to determine, based on approach determination information including an inter-vehicle distance between the ego vehicle and the following vehicle, whether an excessive approach state in which the following vehicle is excessively close to the ego vehicle has occurred, wherein the computer determines that the excessive approach state has occurred when an excessive approach affirmative condition is met and an excessive approach negative condition is not met, and determines that the excessive approach state has not occurred when the excessive approach affirmative condition is not met or the excessive approach negative condition is met; and a notification step of, when the excessive approach state has occurred, causing the computer to notify a driver of the ego vehicle that the excessive approach state has occurred, wherein the excessive approach affirmative condition includes that the inter-vehicle distance is less than or equal to or is less than a threshold, and wherein the excessive approach negative condition includes that the computer recognizes that at least one of the ego vehicle and the following vehicle has made a lane change.

To achieve the above object, one aspect of the present invention provides a following vehicle approach determination system for executing information processing related to approach of a following vehicle to an ego vehicle, the following vehicle approach determination system comprising: an external environment recognizing device configured to detect an object around the ego vehicle; a vehicle control device configured to execute information processing related to the following vehicle based on detection results of the external environment recognizing device; and a notification device configured to notify information to a driver of the ego vehicle, wherein the vehicle control device is configured to: determine, based on the detection results of the external environment recognizing device, presence or absence of the following vehicle traveling on a same lane as the ego vehicle; when it is determined that the following vehicle is present, determine, based on approach determination information including an inter-vehicle distance between the ego vehicle and the following vehicle, whether an excessive approach state in which the following vehicle is excessively close to the ego vehicle has occurred; and when it is determined that the excessive approach state has occurred, cause the notification device to notify the driver of the ego vehicle that the excessive approach state has occurred, wherein, in determination of the excessive approach state, the vehicle control device is configured to determine that the excessive approach state has occurred when an excessive approach affirmative condition is met and an excessive approach negative condition is not met, and to determine that the excessive approach state has not occurred when the excessive approach affirmative condition is not met or the excessive approach negative condition is met, and wherein the excessive approach negative condition includes that the vehicle control device recognizes that at least one of the ego vehicle and the following vehicle has made a lane change.

According to the above aspect, a following vehicle approach determination program and a following vehicle approach determination system capable of making a determination of excessive approach of a following vehicle corresponding to tailgating with high accuracy can be provided.

### BRIEF DESCRIPTION OF THE DRAWINGS

FIG. 1 is a block diagram showing a configuration of a following vehicle approach determination system according to an embodiment;

FIG. 2 is a flowchart showing a flow of a process that receives an influence of lane change in information processing according to the embodiment;

FIG. 3 is a flowchart showing a flow of a process irrelevant of a lane change in the information processing according to the embodiment;

FIG. 4 is an explanatory diagram showing an ego vehicle and a situation around the ego vehicle, based on which the information processing according to the embodiment is performed; and

FIG. 5 is an explanatory diagram showing an example of an image displayed on a display device in the following vehicle approach determination system according to the embodiment.

### DETAILED DESCRIPTION OF THE INVENTION

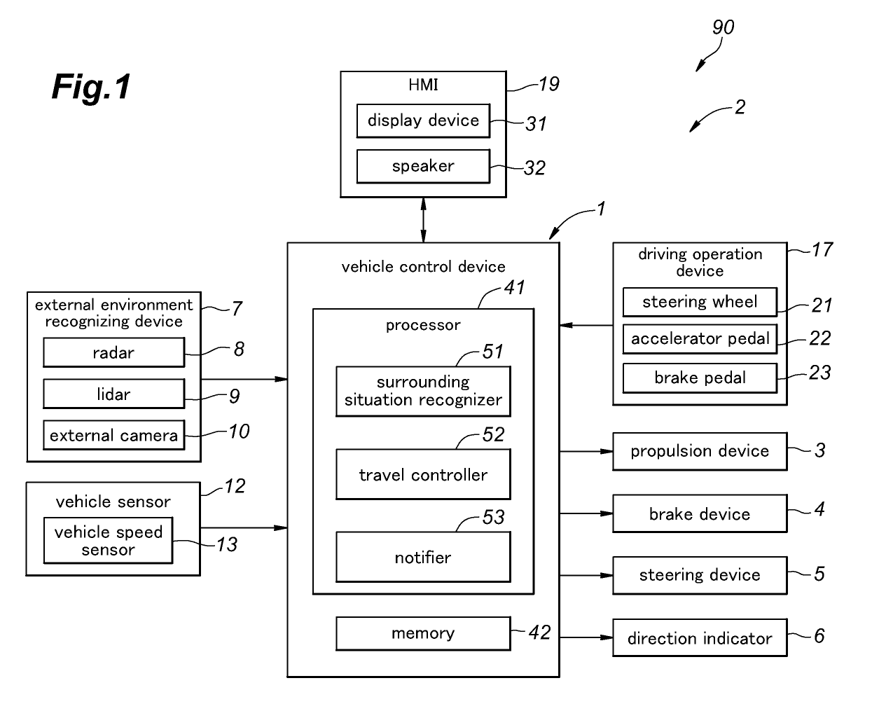

In the following, an embodiment of the present invention will be described with reference to the drawings. FIG. 1 is a block diagram showing a configuration of a following vehicle approach determination system 90 according to the embodiment. With reference to FIG. 1, the features of the following vehicle approach determination system 90 will be described.

As shown in FIG. 1, a vehicle control device 1 is provided in an ego vehicle 2. The ego vehicle 2 may be, for example, a four-wheeled automobile. The ego vehicle 2 is an autonomous vehicle or a vehicle with a driving assistance function.

The ego vehicle 2 includes a propulsion device 3, a brake device 4, and a steering device 5. The propulsion device 3 is a device that provides the driving force to the ego vehicle 2, and includes, for example, a power source and a transmission. The power source includes at least one of an internal combustion engine such as a gasoline engine or a diesel engine, and an electric motor. The brake device 4 is a device that applies the braking force to the ego vehicle 2, and includes, for example, a brake caliper that presses a pad against a brake rotor, and an electric cylinder that supplies hydraulic pressure to the brake caliper. The steering device 5 is a device for changing the steering angle of wheels, and includes, for example, a rack-and-pinion mechanism for steering the wheels, and an electric motor for driving the rack-and-pinion mechanism. The propulsion device 3, the brake device 4, and the steering device 5 are controlled by the vehicle control device 1.

The ego vehicle 2 includes a direction indicator 6. The direction indicator 6 includes lamps disposed on left and right parts of each of the front and rear faces of the ego vehicle 2. In response to an operation of the direction indicator lever (not shown in the drawings) by the driver or control by the vehicle control device 1, the left or right lamps of the direction indicator 6 are caused to blink according to the traveling direction.

The ego vehicle 2 includes an external environment recognizing device 7. The external environment recognizing device 7 is a device for detecting objects outside the vehicle and the like. The external environment recognizing device 7 is a sensor that captures electromagnetic waves and light from the surroundings of the ego vehicle 2 to detect the objects outside the ego vehicle 2. The external environment recognizing device 7 includes, for example, a radar 8, a lidar 9 (LiDAR), and an external camera 10.

The ego vehicle 2 includes a vehicle sensor 12. The vehicle sensor 12 includes a vehicle speed sensor 13 that detects the speed of the ego vehicle 2, an acceleration sensor that detects the acceleration thereof, a yaw rate sensor that detects the angular velocity around the vertical axis, an azimuth sensor that detects the orientation of the ego vehicle 2, and the like.

The ego vehicle 2 includes a driving operation device 17. The driving operation device 17 accepts input operations performed by the occupant (driver) to control the ego vehicle 2. The driving operation device 17 includes a steering wheel 21, an accelerator pedal 22, and a brake pedal 23. The driving operation device 17 may also include a shift lever, a parking brake lever, and the like. Each component of the driving operation device 17 is provided with a sensor that detects the operation amount. The driving operation device 17 outputs a signal indicating the operation amount to the vehicle control device 1.

The ego vehicle 2 includes an HMI 19. The HMI 19 notifies the occupant of various information by display and audio, and accepts input operations by the occupant. The HMI 19 includes a display device 31 and a speaker 32. The display device 31 may be a touch panel display including a liquid crystal display or an organic electroluminescence display. The display device 31 may also function as a navigation interface. The display device 31 and the speaker 32 function as notification devices for notifying the occupant by images and audio. Here, the image may be a video including a number of consecutive frames.

The vehicle control device 1 is a computer including a processor 41 and a memory 42 communicatively connected to the processor 41. The processor 41 may include at least one of the following cores: a central processing unit (CPU), a graphics processing unit (GPU), and a reduced instruction set computer (RISC). The memory 42 stores the control program executed by the processor 41 and various data. The memory 42 may include at least one of a volatile memory and a non-volatile memory. The volatile memory may be, for example, a dynamic random access memory (DRAM) or a static random access memory (SRAM). The non-volatile memory may be a solid state drive (SSD), a flash memory, a magnetic disk storage device, or an optical disk storage device. At least a portion of the vehicle control device 1 may be realized by hardware such as a large scale integration (LSI), an application specific integrated circuit (ASIC), or a field-programmable gate array (FPGA), or may be realized by a combination of software and hardware. The vehicle control device 1 may be composed of a single piece of hardware, or may be composed of plural pieces of hardware capable of communicating with each other. A portion of the vehicle control device 1 may be composed of an external server provided outside the ego vehicle 2.

The processor 41 realizes various applications by executing the control program stored in the memory 42. The control program may be stored in a removable recordable medium such as a DVD or a CD-ROM, and installed in the memory 42 as the recordable medium is read by a reading device. The control program may also be downloaded and installed in the memory 42 via a communication network such as the Internet.

By executing the control programs stored in the memory 42, the processor 41 functions as a surrounding situation recognizer 51, a travel controller 52, and a notifier 53. The processor 41 executes the control program, and the vehicle control device 1, which is a computer, executes the vehicle control method.

The surrounding situation recognizer 51 recognizes the surrounding situation of the ego vehicle 2. The surrounding situation recognizer 51 recognizes the surrounding situation (external environment), including obstacles located around the ego vehicle 2, the shapes of roads, the presence or absence of sidewalks, road markings, and the like, based on the detection results of the external environment recognizing device 7. The obstacles include, for example, guardrails, utility poles, surrounding vehicles, and people such as pedestrians. The surrounding situation recognizer 51 can acquire the position, speed, acceleration, and other states of the surrounding vehicles from the detection results of the external environment recognizing device 7.

The travel controller 52 is configured to control the acceleration and deceleration of the ego vehicle 2 according to the driving mode. The travel controller 52 may also be configured to control the steering of the ego vehicle 2 in addition to the acceleration and deceleration of the ego vehicle 2. The travel controller 52 executes driving assist control including adaptive cruise control (hereinafter referred to as ACC) and lane keeping assist control (Lane Keeping Assist System, hereinafter referred to as LKAS). The ACC is an example of vehicle speed control that controls the acceleration and deceleration of the ego vehicle 2 to control the vehicle speed of the ego vehicle 2. The travel controller 52 controls the propulsion device 3 and the brake device 4 to control the acceleration and deceleration of the ego vehicle 2 and assist the driver in driving. Further, the LKAS is an example of steering control that controls the steering device 5 to control the steering of the ego vehicle 2. The travel controller 52 controls the steering device 5 to control the trajectory of the ego vehicle 2 and assist the driver in driving.

The notifier 53 causes the display device 31 and/or the speaker 32 to notify the driver of information based on the detection results of the external environment recognizing device 7 or the like.

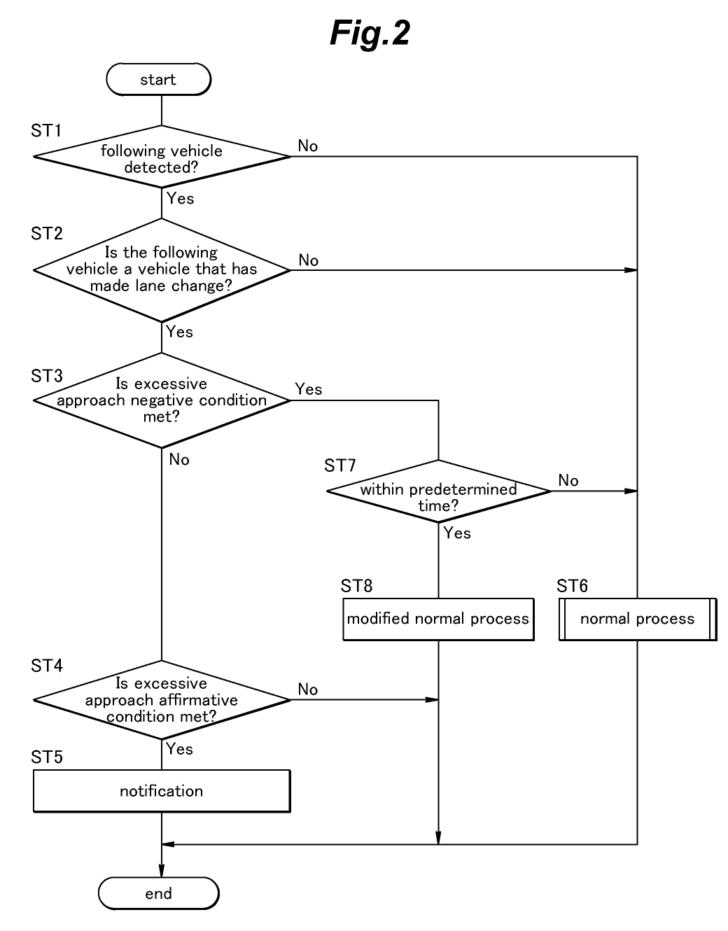

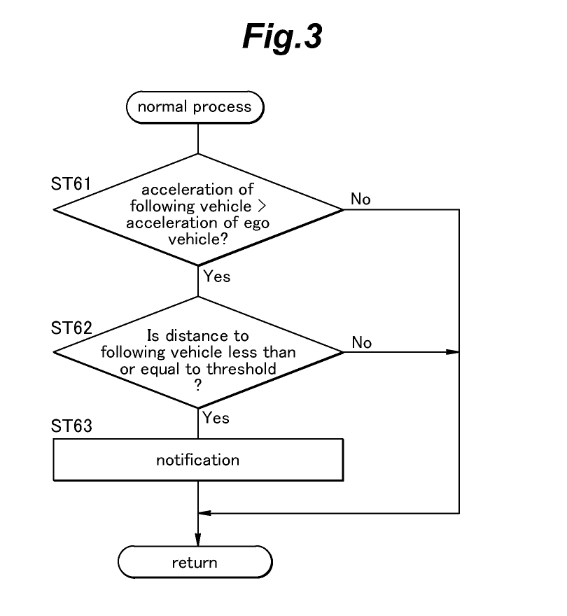

Next, with reference to FIGS. 1 to 5 , one example of the procedure of the processing performed by the following vehicle approach determination system 90 will be described. In the following description, regarding recitations that "a physical quantity A is less than or is less than or equal to a predetermined value" and "the physical quantity A is greater than or is greater than or equal to the predetermined value," the term "less than or equal to" in the former corresponds to the term "greater than" in the latter, and the term "less than "in the former corresponds to "greater than or equal to" in the latter.

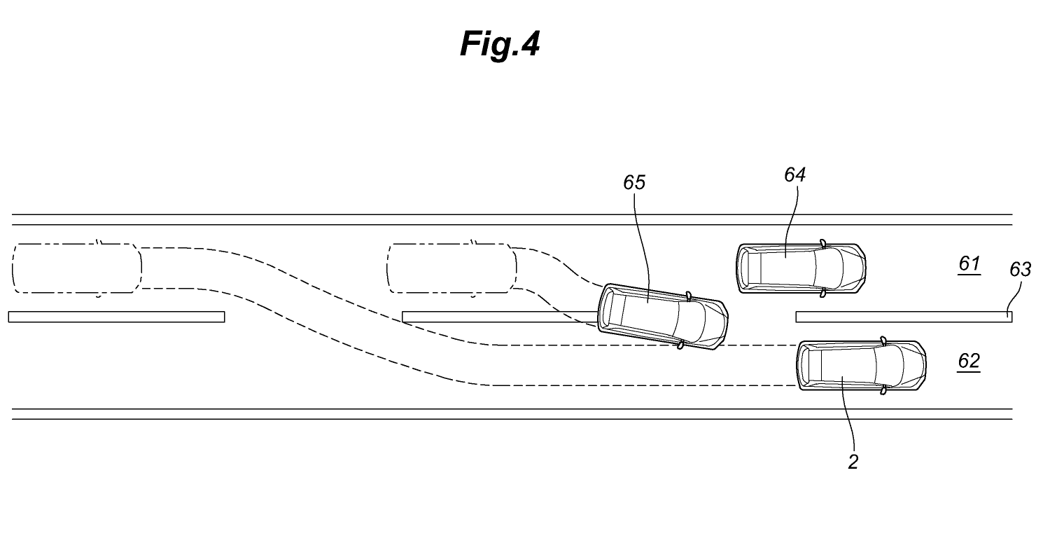

As shown in FIG. 4, the ego vehicle 2 makes a lane change from a first lane 61 to a second lane 62. The first lane 61 and the second lane 62 are adjacent to each other and the boundary therebetween is defined by a lane marking 63. After the ego vehicle 2 makes a lane change, another vehicle traveling behind a preceding vehicle 64 on the first lane 61 makes a lane change from the first lane 61 to the second lane 62 and becomes a following vehicle 65 that travels behind the ego vehicle 2 on the second lane 62. Note that the following vehicle 65 only needs to travel behind the ego vehicle 2 on the second lane 62 which is the lane after the lane change, and it may travel in front of or behind the ego vehicle 2 on the first lane 61 which is the lane before the lane change. The vehicle control device 1 determines that an excessive approach state (a state in which it is inferred that the driver of the following vehicle 65 is conducting tailgating including failure to maintain the inter-vehicle distance) has occurred when an excessive approach affirmative condition is met and an excessive approach negative condition is not met, and determines that the excessive approach state has not occurred when the excessive approach affirmative condition is not met or the excessive approach negative condition is met.

As shown in FIGS. 1, 2 and 4, after completion of the lane change of the ego vehicle 2 to the second lane 62, the vehicle control device 1 determines whether the external environment recognizing device 7 detects the following vehicle 65 on the second lane 62 (ST1). The completion of the lane change means, for example, when the lateral speed of the vehicle of interest becomes substantially 0 or when the entirety of the vehicle of interest has crossed the lane marking 63. In the case where the following vehicle 65 is not detected on the second lane 62 (No in ST1), the vehicle control device 1 executes a later-described normal process (ST6).

In the case where the following vehicle 65 is detected on the second lane 62 (Yes in ST1), the vehicle control device 1 determines, based on the detection history of the external environment recognizing device 7, whether the following vehicle 65 is a vehicle that has made a lane change to the second lane 62 within a predetermined time (a second predetermined time, which is a time longer than a later-described first predetermined time) after the ego vehicle 2 made a lane change (ST2). In the case where the following vehicle 65 is not a vehicle that has made a lane change (No in ST2), the vehicle control device 1 executes the later-described normal process (ST6).

In the case where the following vehicle 65 is a vehicle that has made a lane change (Yes in ST2), the vehicle control device 1 determines whether the excessive approach negative condition is met (ST3). The excessive approach negative condition includes that the elapsed time from when the ego vehicle 2 made a lane change to the current time is less than or equal to or is less than a first predetermined time.

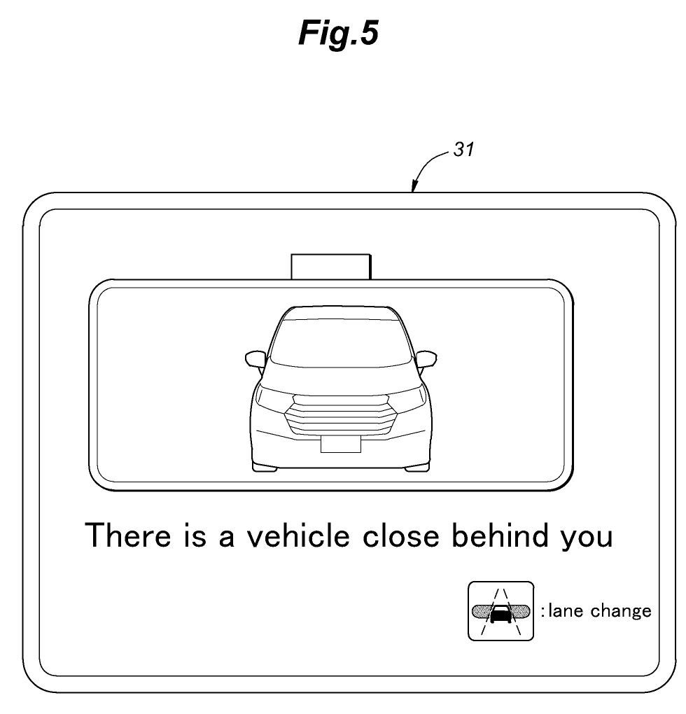

In the case where the excessive approach negative condition is not met (No in ST3), the vehicle control device 1 determines whether the excessive approach affirmative condition is met (ST4). The excessive approach affirmative condition includes that the inter-vehicle distance between the following vehicle 65 and the ego vehicle 2 is less than or equal to a first threshold. The first threshold may be a constant or a variable. The first threshold is preferably a variable that becomes smaller as the speed of the ego vehicle 2 or the following vehicle 65 increases. The first threshold may be changed depending on the elapsed time from the completion of the lane change of the ego vehicle 2 and, for example, may be a variable that becomes greater as the elapsed time becomes longer. When the excessive approach affirmative condition is not met (No in ST4), it is determined that the following vehicle 65 does not configure the excessive approach state with respect to the ego vehicle 2, and thus, the vehicle control device 1 ends the process. In the case where the excessive approach negative condition is not met (No in ST3) and the excessive approach affirmative condition is met (Yes in ST4), it is determined that the relationship between the following vehicle 65 and the ego vehicle 2 corresponds to the excessive approach state, and the vehicle control device 1notifies the driver of the ego vehicle 2 that the following vehicle 65 is approaching by using the display device 31 or the speaker 32 (ST5). FIG. 5 shows an example in which the display device 31 is used to perform the notification.

As shown in FIGS. 1 to 4, in the case where the following vehicle 65 is not a vehicle that has made a lane change (No in ST2), the normal process is executed (ST6). In the normal process, the excessive approach negative condition is not provided (it is determined that the excessive approach negative condition is always not met), and the excessive approach affirmative condition includes that the acceleration of the following vehicle 65 is greater than the acceleration of the ego vehicle 2 (ST61) and that the inter-vehicle distance between the following vehicle 65 and the ego vehicle 2 is less than or equal to or is less than the second threshold (ST62). The second threshold may be a constant or a variable, and may be the same as or different from the first threshold. Preferably, the second threshold is a variable that becomes smaller as the speed of the ego vehicle 2 or the following vehicle 65 increases.

When these two conditions are met (Yes in ST61 and Yes in ST62), the vehicle control device 1 determines that the following vehicle 65 configures the excessive approach state with respect to the ego vehicle 2 and notifies the driver of the ego vehicle 2 that the following vehicle 65 is approaching by using the display device 31 or the speaker 32 (ST63. See FIG. 5). When at least one of these two conditions is not met (No in ST61 and/or No in ST62), the vehicle control device 1 determines that the following vehicle 65 does not configure the excessive approach state with respect to the ego vehicle 2, and ends the process.

In the case where the excessive approach negative condition is met (Yes in ST3), the vehicle control device 1 determines whether the elapsed time from the completion of the lane change of the ego vehicle 2 is less than or equal to or is less than the second predetermined time (ST7). The second predetermined time is longer than the first predetermined time. In the case where the elapsed time from the completion of the lane change of the ego vehicle 2 is greater than the second predetermined time or is greater than or equal to the second predetermined time (No in ST7), the vehicle control device 1 executes the normal process (ST6). In the case where the elapsed time from the completion of the lane change of the ego vehicle 2 is less than or equal to or is less than the second predetermined time (Yes in ST7), the vehicle control device 1 executes a modified normal process (ST8). The modified normal process differs from the normal process (ST6) in that the excessive approach affirmative condition does not include the condition related to the acceleration (ST61), and is otherwise the same as the normal process (ST6). This is because, within a predetermined time from when the first predetermined time has elapsed from the lane change, even if the driver of the following vehicle 65 has an intention of tailgating, there is a high possibility that the following vehicle 65 is already close to the ego vehicle 2 and the acceleration of the following vehicle 65 has become small.

Note that in a case where the ego vehicle 2 makes multiple lane changes and the following vehicle 65 makes multiple lane changes following the ego vehicle 2, preferably, the vehicle control device 1 (i) measures the elapsed time from the completion of each lane change of the ego vehicle 2 and makes the first predetermined time shorter as the number of lane changes of the ego vehicle 2 and the following vehicle 65 increases or (ii) measures the elapsed time in the excessive approach negative condition after each of the second and subsequent lane changes from the completion of the first lane change of the ego vehicle 2.

Preferably, the vehicle control device 1 has a recommend-type automatic lane change function. The lane change recommendation (see FIG. 5) based on the recommend-type automatic lane change function is performed, for example, when the relationship between the ego vehicle 2 and the following vehicle 65 corresponds to the excessive approach state. Within a third predetermined time from the completion of the lane change of the ego vehicle 2, the vehicle control device 1 suppresses the lane change recommendation even if the relationship between the ego vehicle 2 and the following vehicle 65 corresponds to the excessive approach state. The method for suppressing the lane change recommendation may include, for example, not making the recommendation, or in a case where the recommendation is usually notified with both the display device 31 and the speaker 32, notifying the recommendation with only the display device 31 when suppressing the recommendation. In the case where a state in which a lane change is to be recommended has not been resolved at the time when the third predetermined time has elapsed, the vehicle control device 1 performs the lane change recommendation in the usual way.

Effects of the embodiment will be described. When the following vehicle 65 is excessively close to the ego vehicle 2, the driver of the ego vehicle 2 is notified of such a state, whereby the driver of the ego vehicle 2 can perform an action to resolve the state (making a lane change, accelerating the ego vehicle 2, etc.). On the other hand, immediately after the lane change, the inter-vehicle distance between the ego vehicle 2 and the following vehicle 65 may become narrow even when the driver of the following vehicle 65 does not have an intention of tailgating the driver of the ego vehicle 2. Particularly, in the case where the following vehicle 65 makes a lane change following the ego vehicle 2 to overtake the preceding vehicle 64, the inter-vehicle distance between the ego vehicle 2 and the following vehicle 65 is likely to become narrow. In the case where the driver of the following vehicle 65 has no intention of tailgating, it is assumed that over time, the following vehicle 65 moves away from the ego vehicle 2 and the inter-vehicle distance widens. Thus, when the vehicle control device 1 recognizes a lane change and it is within the first predetermined time from the completion of the lane change, the vehicle control device 1 does not determine that the excessive approach state which is inferred to be tailgating including failure to maintain the inter-vehicle distance has occurred, whereby the determination of excessive approach of the following vehicle 65 corresponding to tailgating is made with high accuracy. Accordingly, unnecessary notification to the driver of the ego vehicle 2 is suppressed, and the annoyance experienced by the driver of the ego vehicle 2 is reduced.

When the acceleration of the following vehicle 65 is greater than the acceleration of the ego vehicle 2, it can be inferred that the driver of the following vehicle 65 has an intention of tailgating the driver of the ego vehicle 2. In the normal process (ST6), the excessive approach affirmative condition includes that the acceleration of the following vehicle 65 is greater than the acceleration of the ego vehicle 2, and thus, the vehicle control device 1 can determine excessive approach of the following vehicle 65 with an intention of tailgating with high accuracy. On the other hand, after the first predetermined time has elapsed from the completion of the lane change, if the driver of the following vehicle 65 has an intention of tailgating, there is a high possibility that the following vehicle 65 is already close to the ego vehicle 2 and the acceleration of the following vehicle 65 has become substantially the same as the acceleration of the ego vehicle 2. Therefore, after the first predetermined time has elapsed from the completion of the lane change, the condition related to the acceleration is removed from the excessive approach affirmative condition, namely, the modified normal process (ST8) is executed, whereby the vehicle control device 1 can determine excessive approach of the following vehicle 65 with an intention of tailgating with high accuracy.

As one example of the cases where a lane change is recommended in the recommend-type lane change assist function, there is a case where the following vehicle 65 is close to the ego vehicle 2 as in the excessive approach state. In the case where the driver of the following vehicle 65 has an intention of tailgating and makes lane changes following the ego vehicle 2, a situation that would cause the vehicle control device 1 to make a lane change recommendation will occur immediately after the ego vehicle 2 makes a lane change upon approval of the recommendation by the driver of the ego vehicle 2, and this would result in annoyance felt by the driver of the ego vehicle 2. By the vehicle control device 1 suppressing new lane change recommendation until the third predetermined time elapses after the completion of the lane change according to the recommend-type lane change assist function, the annoyance experienced by the driver of the ego vehicle 2 can be reduced.

The embodiment may be modified in various ways without being limited to the above-described configuration. For example, the information processing in the above embodiment may be applied to the case where only one of the ego vehicle 2 and the following vehicle 65 has made a lane change, and in the case where the following vehicle 65 has made a lane change, the elapsed time may be measured from the completion of the lane change of the following vehicle 65. Also, in the case where the vehicle control device 1 could recognize the lane change of the preceding vehicle 64 or the following vehicle 65 based on the detection results of the external environment recognizing device 7 and the vehicle sensor 12, the vehicle control device 1 may determine that the excessive approach negative condition is met regardless of the elapsed time from the lane change completion, by taking into account other conditions (for example, when a condition that the speed of the following vehicle 65 relative to the ego vehicle 2 is negative is met), as necessary. In the normal process, the excessive approach negative condition may be provided.

The above embodiment may be described as follows.

One embodiment is a non-transitory computer-readable storage medium comprising a following vehicle approach determination program, wherein the following vehicle approach determination program, when executed by a computer (the vehicle control device 1), causes the computer to execute information processing including determination related to approach of a following vehicle 65 to an ego vehicle 2, wherein the information processing comprises: a following vehicle determination step of causing the computer (the vehicle control device 1) to determine presence or absence of the following vehicle 65 traveling on a same lane as the ego vehicle 2; an approach state determination step of, in a case where the following vehicle 65 is present, causing the computer (the vehicle control device 1) to determine, based on approach determination information including an inter-vehicle distance between the ego vehicle 2 and the following vehicle 65, whether an excessive approach state in which the following vehicle 65 is excessively close to the ego vehicle 2 has occurred, wherein the computer (the vehicle control device 1) determines that the excessive approach state has occurred when an excessive approach affirmative condition is met and an excessive approach negative condition is not met, and determines that the excessive approach state has not occurred when the excessive approach affirmative condition is not met or the excessive approach negative condition is met; and a notification step of, when the excessive approach state has occurred, causing the computer (the vehicle control device 1) to notify a driver of the ego vehicle 2 that the excessive approach state has occurred, wherein the excessive approach affirmative condition includes that the inter-vehicle distance is less than or equal to or is less than a threshold (the first threshold), and wherein the excessive approach negative condition includes that the computer (the vehicle control device 1) recognizes that at least one of the ego vehicle 2 and the following vehicle 65 has made a lane change.

According to this configuration, when the vehicle control device 1 recognizes a lane change and it is within the first predetermined time from the completion of the lane change, the vehicle control device 1 does not determine that the excessive approach state which is inferred to be tailgating including failure to maintain the inter-vehicle distance has occurred, and thus, the determination of excessive approach of the following vehicle 65 corresponding to tailgating is made with high accuracy, and unnecessary notification to the driver of the ego vehicle 2 is suppressed, whereby the annoyance experienced by the driver of the ego vehicle 2 is reduced.

In the above configuration, preferably, the excessive approach negative condition further includes that an elapsed time from when at least one of the ego vehicle and the following vehicle made a lane change is less than or equal to or is less than a first predetermined time.

According to this configuration, since the excessive approach negative condition is met when the elapsed time is within the first predetermined time, the determination of excessive approach of the following vehicle 65 corresponding to tailgating is made with even greater accuracy, and the annoyance experienced by the driver of the ego vehicle 2 is further reduced. If the excessive approach affirmative condition is met after the first predetermined time has elapsed, it is inferred that the driver of the following vehicle 65 has an intention of tailgating.

In the above configuration, preferably, in a case of a post following lane change state, which is a state in which after the ego vehicle 2 has made a lane change, the following vehicle 65 makes a lane change to a lane on which the ego vehicle travels after the lane change (the second lane 62) within a second predetermined time, the excessive approach negative condition further includes that an elapsed time from completion of the lane change of the ego vehicle 2 is less than or equal to or is less than a first predetermined time.

According to this configuration, in the case where both the ego vehicle 2 and the following vehicle 65 make a lane change, the determination of excessive approach of the following vehicle 65 corresponding to tailgating is made with even greater accuracy, and the annoyance experienced by the driver of the ego vehicle 2 is further reduced.

In the above configuration, preferably, in a case where neither the ego vehicle 2 nor the following vehicle 65 has made a lane change or the elapsed time from the completion of the lane change is greater than or is greater than or equal to the second predetermined time that is longer than the first predetermined time, the approach determination information further includes an acceleration of the following vehicle 65 and an acceleration of the ego vehicle 2, and the excessive approach affirmative condition further includes that the acceleration of the following vehicle 65 is greater than the acceleration of the ego vehicle 2.

According to this configuration, since the determination of the excessive approach state is made by using the accelerations, the determination of excessive approach of the following vehicle 65 corresponding to tailgating is made with even greater accuracy, and the annoyance experienced by the driver of the ego vehicle 2 is further reduced. This is because when the acceleration of the following vehicle 65 is greater than the acceleration of the ego vehicle 2, there is a high possibility that the driver of the following vehicle 65 has an intention of tailgating.

In the above configuration, preferably, in the case of the post following lane change state and in a case where the elapsed time from the completion of the lane change of the ego vehicle 2 is greater than or is greater than or equal to the first predetermined time and is less than or equal to or is less than the second predetermined time, the computer (the vehicle control device 1) determines that the excessive approach affirmative condition is met regardless of the acceleration of the following vehicle 65 and the acceleration of the ego vehicle 2 if the inter-vehicle distance between the following vehicle 65 and the ego vehicle 2 is less than or equal to or is less than the threshold (the first threshold).

According to this configuration, even in the case where the driver of the following vehicle 65 has an intention of tailgating, the accelerations become irrelevant to the fulfillment of the excessive approach affirmative condition in the situation where the acceleration of the following vehicle 65 becomes substantially the same as the acceleration of the ego vehicle 2, and thus, the determination of excessive approach of the following vehicle 65 corresponding to tailgating is made with even greater accuracy, and the annoyance experienced by the driver of the ego vehicle 2 is further reduced.

In the above configuration, preferably, in a case where the ego vehicle 2 makes multiple lane changes and the following vehicle 65 makes multiple lane changes following the ego vehicle 2, the computer (the vehicle control device 1) (i) measures an elapsed time from completion of each lane change of the ego vehicle 2 and makes the first predetermined time shorter as a number of lane changes of the ego vehicle and the following vehicle increases or (ii) measures the elapsed time in the excessive approach negative condition after each of a second and subsequent lane changes from completion of a first lane change of the ego vehicle.

According to this configuration, after the second and subsequent lane changes, it becomes easier to determine that the excessive approach state has occurred, and thus, the determination of excessive approach of the following vehicle 65 corresponding to tailgating is made with even greater accuracy, and the annoyance experienced by the driver of the ego vehicle 2 is further reduced. In the case where the following vehicle 65 is following the ego vehicle 2 despite multiple lane changes, it is inferred that there is a high possibility that the driver of the following vehicle 65 has an intention of tailgating.

In the above configuration, preferably, the information processing further includes a recommend-type lane change assist execution step of causing the computer (the vehicle control device 1) to recommend a lane change of the ego vehicle 2 to the driver of the ego vehicle 2 and, when a consent of the driver of the ego vehicle 2 is obtained, causing the computer (the vehicle control device 1) to execute the lane change of the ego vehicle 2, and in a case where an elapsed time from completion of the lane change according to the recommend-type lane change assist execution step is less than or equal to or is less than a third predetermined time, lane change recommendation in the recommend-type lane change assist execution step is suppressed.

According to this configuration, since the lane change recommendation is suppressed within the third predetermined time after the lane change according to the recommend-type lane change assist, frequent lane change recommendation due to tailgating by the following vehicle 65 is avoided, and the annoyance experienced by the driver of the ego vehicle 2 is reduced.

One embodiment is a following vehicle approach determination system 90 for executing information processing related to approach of a following vehicle 65 to an ego vehicle 2, the following vehicle approach determination system 90 comprising: an external environment recognizing device 7 configured to detect an object around the ego vehicle 2; a vehicle control device 1 configured to execute information processing related to the following vehicle 65 based on detection results of the external environment recognizing device 7; and a notification device (the HMI 19) configured to notify information to a driver of the ego vehicle 2, wherein the vehicle control device 1 is configured to: determine, based on the detection results of the external environment recognizing device 7, presence or absence of the following vehicle 65 traveling on a lane same as the ego vehicle 2; when it is determined that the following vehicle 65 is present, determine, based on approach determination information including an inter-vehicle distance between the ego vehicle 2 and the following vehicle 65, whether an excessive approach state in which the following vehicle 65 is excessively close to the ego vehicle 2 has occurred, and when it is determined that the excessive approach state has occurred, cause the notification device (the HMI 19) to notify the driver of the ego vehicle 2 that the excessive approach state has occurred, wherein in determination of the excessive approach state, the vehicle control device 1 is configured to determine that the excessive approach state has occurred when an excessive approach affirmative condition is met and an excessive approach negative condition is not met, and to determine that the excessive approach state has not occurred when the excessive approach affirmative condition is not met or the excessive approach negative condition is met, and wherein the excessive approach negative condition includes that the vehicle control device 1 recognizes that at least one of the ego vehicle 2 and the following vehicle 65 has made a lane change.

According to this configuration, when the vehicle control device 1 recognizes a lane change and it is within the first predetermined time from the completion of the lane change, the vehicle control device 1 does not determine that the excessive approach state which is inferred to be tailgating including failure to maintain the inter-vehicle distance has occurred, and thus, the determination of excessive approach of the following vehicle 65 corresponding to tailgating is made with high accuracy, and unnecessary notification to the driver of the ego vehicle 2 is suppressed, whereby the annoyance experienced by the driver of the ego vehicle 2 is reduced.

1. A non-transitory computer-readable storage medium comprising a following vehicle approach determination program, wherein the following vehicle approach determination program, when executed by a computer, causes the computer to execute information processing including determination related to approach of a following vehicle to an ego vehicle,
wherein the information processing comprises:
a following vehicle determination step of causing the computer to determine presence or absence of the following vehicle traveling on a same lane as the ego vehicle;
an approach state determination step of, in a case where the following vehicle is present, causing the computer to determine, based on approach determination information including an inter-vehicle distance between the ego vehicle and the following vehicle, whether an excessive approach state in which the following vehicle is excessively close to the ego vehicle has occurred, wherein the computer determines that the excessive approach state has occurred when an excessive approach affirmative condition is met and an excessive approach negative condition is not met, and determines that the excessive approach state has not occurred when the excessive approach affirmative condition is not met or the excessive approach negative condition is met; and
a notification step of, when the excessive approach state has occurred, causing the computer to notify a driver of the ego vehicle that the excessive approach state has occurred,
wherein the excessive approach affirmative condition includes that the inter-vehicle distance is less than or equal to or is less than a threshold, and
wherein the excessive approach negative condition includes that the computer recognizes that at least one of the ego vehicle and the following vehicle has made a lane change.

2. The non-transitory computer-readable storage medium according to claim 1, wherein the excessive approach negative condition further includes that an elapsed time from when at least one of the ego vehicle and the following vehicle made a lane change is less than or equal to or is less than a first predetermined time.

3. The non-transitory computer-readable storage medium according to claim 1, wherein in a case of a post following lane change state, which is a state in which after the ego vehicle has made a lane change, the following vehicle makes a lane change to a lane on which the ego vehicle travels after the lane change within a second predetermined time, the excessive approach negative condition further includes that an elapsed time from completion of the lane change of the ego vehicle is less than or equal to or is less than a first predetermined time.

4. The non-transitory computer-readable storage medium according to claim 3, wherein, in a case where neither the ego vehicle nor the following vehicle has made a lane change or the elapsed time from the completion of the lane change is greater than or is greater than or equal to the second predetermined time that is longer than the first predetermined time, the approach determination information further includes an acceleration of the following vehicle and an acceleration of the ego vehicle, and the excessive approach affirmative condition further includes that the acceleration of the following vehicle is greater than the acceleration of the ego vehicle.

5. The non-transitory computer-readable storage medium according to claim 4, wherein in the case of the post following lane change state and in a case where the elapsed time from the completion of the lane change of the ego vehicle is greater than or is greater than or equal to the first predetermined time and is less than or equal to or is less than the second predetermined time, the computer determines that the excessive approach affirmative condition is met regardless of the acceleration of the following vehicle and the acceleration of the ego vehicle if the inter-vehicle distance between the following vehicle and the ego vehicle is less than or equal to or is less than the threshold.

6. The non-transitory computer-readable storage medium according to claim 3, wherein in a case where the ego vehicle makes multiple lane changes and the following vehicle makes multiple lane changes following the ego vehicle, the computer (i) measures an elapsed time from completion of each lane change of the ego vehicle and makes the first predetermined time shorter as a number of lane changes of the ego vehicle and the following vehicle increases or (ii) measures the elapsed time in the excessive approach negative condition after each of a second and subsequent lane changes from completion of a first lane change of the ego vehicle.

7. The non-transitory computer-readable storage medium according to claim 1, wherein the information processing further includes a recommend-type lane change assist execution step of causing the computer to recommend a lane change of the ego vehicle to the driver of the ego vehicle and, when a consent of the driver of the ego vehicle is obtained, causing the computer to execute the lane change of the ego vehicle, and
in a case where an elapsed time from completion of the lane change according to the recommend-type lane change assist execution step is less than or equal to or is less than a third predetermined time, lane change recommendation in the recommend-type lane change assist execution step is suppressed.

8. A following vehicle approach determination system for executing information processing related to approach of a following vehicle to an ego vehicle, the following vehicle approach determination system comprising:
an external environment recognizing device configured to detect an object around the ego vehicle;
a vehicle control device configured to execute information processing related to the following vehicle based on detection results of the external environment recognizing device; and
a notification device configured to notify information to a driver of the ego vehicle,
wherein the vehicle control device is configured to:
determine, based on the detection results of the external environment recognizing device, presence or absence of the following vehicle traveling on a same lane as the ego vehicle;
when it is determined that the following vehicle is present, determine, based on approach determination information including an inter-vehicle distance between the ego vehicle and the following vehicle, whether an excessive approach state in which the following vehicle is excessively close to the ego vehicle has occurred; and
when it is determined that the excessive approach state has occurred, cause the notification device to notify the driver of the ego vehicle that the excessive approach state has occurred,
wherein, in determination of the excessive approach state, the vehicle control device is configured to determine that the excessive approach state has occurred when an excessive approach affirmative condition is met and an excessive approach negative condition is not met, and to determine that the excessive approach state has not occurred when the excessive approach affirmative condition is not met or the excessive approach negative condition is met,
and wherein the excessive approach negative condition includes that the vehicle control device recognizes that at least one of the ego vehicle and the following vehicle has made a lane change.
